(19) United States
(12) Patent Application Publication
(10) Pub. No.: US 2025/0274515 A1
(43) Pub. Date: Aug. 28, 2025

(54) SYSTEMS AND METHODS FOR MANAGING AN INDUSTRIAL DIGITAL TWIN AND CONTROLLING AN INDUSTRIAL DEVICE USING AN EDGE DEVICE

(71) Applicant: ROCKWELL AUTOMATION TECHNOLOGIES, INC., Mayfield Heights, OH (US)

(72) Inventors: Eryn A. Manela, Cleveland Heights, OH (US); Todd A. Wiese, Hubertus, WI (US); Patrick E. Ozimek, Elm Grove, WI (US)

(21) Appl. No.: 18/590,614

(22) Filed: Feb. 28, 2024

(51) Int. Cl. H04L 67/12; H04L 69/18

(52) U.S. Cl. CPC H04L 67/12; H04L 69/18

(57) ABSTRACT

A method includes an edge device of an industrial facility receiving a plurality of first packets associated with a first communication protocol from an industrial device of the industrial facility, extracting device data associated with the industrial device from the plurality of first packets associated with the first communication protocol, creating a second packet associated with a second communication protocol, the second packet including the device data associated with the industrial device in the plurality of first packets, and transmitting the second packet associated with the second communication protocol to a cloud platform to manage an industrial digital twin on the cloud platform based on the second packet.

### BACKGROUND

The present disclosure relates to digital twin management and device control. In a more particular example, the present disclosure relates to technologies for managing an industrial digital twin and controlling an industrial device using an edge device.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. The sole purpose of this summary is to present some concepts in a simplified form as a prelude to the more detailed description that is presented later.

In some embodiments, a method is provided. The method comprises receiving, by an edge device of an industrial facility, a plurality of first packets associated with a first communication protocol from an industrial device of the industrial facility; extracting, by the edge device, device data associated with the industrial device from the plurality of first packets associated with the first communication protocol; creating, by the edge device, a second packet associated with a second communication protocol, the second packet including the device data associated with the industrial device in the plurality of first packets; and transmitting, by the edge device, the second packet associated with the second communication protocol to a cloud platform to manage an industrial digital twin on the cloud platform based on the second packet.

In some embodiments, an edge device of an industrial facility is provided. The edge device comprises a memory storing instructions; and a processor communicatively coupled to the memory and configured to execute the instructions to: receive a plurality of first packets associated with a first communication protocol from an industrial device of the industrial facility; extract device data associated with the industrial device from the plurality of first packets associated with the first communication protocol; create a second packet associated with a second communication protocol, the second packet including the device data associated with the industrial device in the plurality of first packets; and transmit the second packet associated with the second communication protocol to a cloud platform to manage an industrial digital twin on the cloud platform based on the second packet.

In some embodiments, a non-transitory computer-readable medium is provided. The non-transitory computer-readable medium stores instructions that, when executed, direct a processor of a computing device to: receive a plurality of first packets associated with a first communication protocol from an industrial device of an industrial facility; extract device data associated with the industrial device from the plurality of first packets associated with the first communication protocol; create a second packet associated with a second communication protocol, the second packet including the device data associated with the industrial device in the plurality of first packets; and transmit the second packet associated with the second communication protocol to a cloud platform to manage an industrial digital twin on the cloud platform based on the second packet.

To the accomplishment of the foregoing and related ends, certain illustrative aspects are described herein in connection with the following description and the accompanying drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an example system for managing an industrial digital twin and controlling an industrial device.

FIG. 2 illustrates an example edge device.

FIG. 3 illustrates an example method for managing an industrial digital twin using an edge device.

FIG. 4 illustrates an example computing environment.

FIG. 5 illustrates an example networking environment.

### DETAILED DESCRIPTION

The present disclosure is now described with reference to the drawings. In the following description, specific details may be set forth for purposes of explanation. It should be understood that the present disclosure may be implemented without these specific details.

As used herein, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities may be hardware, a combination of hardware and software, software, or software in execution. For example, a component may be, but is not limited to being, a process running on a processor, a processor, a hard disk drive, multiple storage drives (of optical or magnetic storage medium) including affixed (e.g., screwed or bolted) or removable affixed solid-state storage drives, an object, an executable object, a thread of execution, a computer-executable program, and/or a computer. By way of illustration, both an application running on a server and the server may be a component. One or more components may reside within a process and/or thread of execution, and a component may be localized on one computer and/or distributed between two or more computers.

In addition, components as described herein may execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component may be an apparatus with specific functionality provided by mechanical parts operated by electric or electronic circuitry which is operated by a software or a firmware application executed by a processor, wherein the processor may be internal or external to the apparatus and may execute at least a part of the software or firmware application. As yet another example, a component may be an apparatus that provides specific functionality through electronic components without mechanical parts, the electronic components may include a processor therein to execute software or firmware that provides at least in part the functionality of the electronic components. As yet another example, interface(s) may include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” generally refer to the process of reasoning about or inferring states of the system, environment, and/or user from a set of observations as captured via events and/or data. For example, inference may be used to identify a specific context or action, or may generate a probability distribution over states. The inference may be probabilistic, e.g., the inference may be the computation of a probability distribution over states of interest based on a consideration of data and events. Inference may also refer to techniques employed for composing higher-level events from a set of events and/or data. Such inference may result in the construction of new events or actions from a set of observed events and/or stored event data, regardless of whether or not the events are correlated in close temporal proximity, and whether the events and data come from one or several event and data sources.

Moreover, the term “or” is intended to mean an inclusive “or” rather than an exclusive “or.” In particular, unless clear from the context or specified otherwise, the phrase “X employs A or B” is intended to mean any of the natural inclusive permutations. Thus, the phrase “X employs A or B” is satisfied by any of the following instances: X employs A, X employs B, or X employs both A and B. In addition, the articles “a” and “an” as used in this present disclosure and the appended claims should generally be construed to mean “one or more” unless clear from the context or specified otherwise to be directed to a singular form.

Furthermore, the term “set” as used herein excludes the empty set, e.g., the set with no elements therein. Thus, a “set” in the present disclosure may include one or more elements or entities. For example, a set of controllers may include one or more controllers, a set of data resources may include one or more data resources, etc. Similarly, the term “group” as used herein refers to a collection of one or more entities. For example, a group of nodes refers to one or more nodes.

Various aspects or features will be presented in terms of systems that may include a number of devices, components, modules, and the like. It should be understood that various systems may include additional devices, components, modules, etc. and/or may not include all of the devices, components, modules, etc. that are discussed with reference to the figures. A combination of these approaches may also be used.

Systems and methods for managing an industrial digital twin and controlling an industrial device using an edge device are described herein. In an industrial facility, an industrial device may communicate with other devices (e.g., an edge device, other industrial devices, etc.) in the industrial facility using a low-latency communication protocol. When communicating with other devices in the low-latency communication protocol, the industrial device may frequently generate a large number of packets that conform to the low-latency communication protocol and have small packet sizes. As these packets are frequently generated and have the small packet sizes, the industrial device may communicate with other devices in the industrial facility with high speed and low latency. However, when the industrial device communicates with a cloud platform, the large number of packets frequently transmitted to and from the industrial device may result in an excessive cost for packet transmission and packet processing in the communication between the industrial device and the cloud platform.

The systems and methods described herein may facilitate the communication between the industrial device and the cloud platform using an edge device in the industrial facility. For example, the edge device may facilitate the communication of device data associated with the industrial device to the cloud platform to manage (e.g., evaluate, update, etc.) an industrial digital twin on the cloud platform based on the device data associated with the industrial device. The edge device may also be used in controlling the industrial device to perform an operation that is communicated from the cloud platform.

To illustrate, an edge device may receive a plurality of first packets associated with a first communication protocol from an industrial device. The first communication protocol may be a low-latency high-speed communication protocol such as Common Industrial Protocol (also referred to herein as the CIP protocol). In some embodiments, the edge device may extract device data associated with the industrial device from the plurality of first packets associated with the first communication protocol. The edge device may then create a second packet associated with a second communication protocol, in which the second packet may include the device data associated with the industrial device in the plurality of first packets and the second communication protocol may be a high-latency low-speed communication protocol such as Message Queuing Telemetry Transport protocol (also referred to herein as the MQTT protocol). In some embodiments, the edge device may transmit the second packet associated with the second communication protocol to a cloud platform to manage an industrial digital twin on the cloud platform based on the second packet. For example, the edge device may transmit the second packet to a twin model management system (TMMS) implemented on the cloud platform that manages the industrial digital twin on the cloud platform. The industrial digital twin may be a digital twin of the industrial device or a digital twin of an industrial system that includes the industrial device.

In some embodiments, when receiving the second packet associated with the second communication protocol from the edge device, the TMMS may extract the device data associated with the industrial device from the second packet, and compare the device data associated with the industrial device extracted from the second packet to simulation data associated with the industrial device generated by the industrial digital twin. In some embodiments, if the device data associated with the industrial device that is provided by the industrial device and extracted from the second packet matches the simulation data associated with the industrial device that is generated by the industrial digital twin, the TMMS may determine that the industrial device and the industrial digital twin are in synchronization, and therefore the industrial digital twin does not need to be updated. Alternatively, when comparing the device data associated with the industrial device extracted from the second packet to the simulation data associated with the industrial device generated by the industrial digital twin, the TMMS may determine that an actual value of a particular parameter in the device data associated with the industrial device is different from a simulated value of the particular parameter in the simulation data associated with the industrial device. In this case, the TMMS may present to a user a notification indicating that the actual value of the particular parameter as provided by the industrial device is different from the simulated value of the particular parameter as determined by the industrial digital twin.

In some embodiments, in response to the notification, the user may evaluate the difference between the actual value of the particular parameter and the simulated value of the particular parameter and/or inspect the industrial device. As a result of such evaluation and/or inspection, the user may determine that the industrial device is operating as expected. In this case, the user may provide a user request to synchronize the industrial digital twin with the industrial device. In response to the user request, the TMMS may update the simulated value of the particular parameter in the industrial digital twin to be equal to the actual value of the particular parameter in the device data associated with the industrial device, thereby synchronizing the industrial digital twin with the industrial device.

Alternatively, based on the evaluation of the difference between the actual value of the particular parameter and the simulated value of the particular parameter and/or based on the inspection of the industrial device, the user may determine that the industrial device is not operating as expected. In this case, the user may adjust the operations of the industrial device. For example, to adjust the operations of the industrial device, the user may provide a user request specifying an operation to be performed by the industrial device (e.g., adjusting a motor speed of the industrial device to a target value, activating a debug mode on the industrial device, etc.). In response to the user request, the TMMS may create a third packet associated with the second communication protocol (e.g., the MQTT protocol) in which the third packet may indicate the operation to be performed by the industrial device. The TMMS may then transmit the third packet to the edge device.

In some embodiments, the edge device may receive the third packet associated with the second communication protocol from the TMMS on the cloud platform. The edge device may determine the operation to be performed by the industrial device that is indicated in the third packet, and determine a plurality of device commands to be executed by the industrial device to perform the operation. For example, the edge device may reference a predefined script to identify a sequence of device commands associated with the operation. The edge device may then populate these device commands based on relevant data of the operation as indicated in the third packet, thereby generating the plurality of device commands to be sequentially executed by the industrial device to perform the operation. In some embodiments, the edge device may create a plurality of fourth packets associated with the first communication protocol (e.g., the CIP protocol) in which each fourth packet among the plurality of fourth packets may specify one or more device commands among the plurality of device commands to be executed by the industrial device. The edge device may then transmit the plurality of fourth packets to the industrial device.

In some embodiments, the industrial device may receive the plurality of fourth packets associated with the first communication protocol from the edge device. The industrial device may determine the plurality of device commands that are indicated in the plurality of fourth packets, and execute these device commands to perform the operation. Thus, the industrial device may perform the operation specified in the user request that is communicated from the cloud platform.

The systems and methods described herein may be advantageous in a number of technical respects. For example, as described herein, the edge device may receive the plurality of first packets associated with the first communication protocol from the industrial device, and extract the device data associated with the industrial device from the plurality of first packets. The edge device may then create the second packet associated with the second communication protocol that includes the device data associated with the industrial device in the plurality of first packets, and transmit the second packet associated with the second communication protocol to the cloud platform. Thus, the edge device may aggregate the device data associated with the industrial device in the plurality of first packets into one second packet, and transmit the second packet to the cloud platform. Accordingly, the number of packets being transmitted to the cloud platform may be significantly decreased, and thus the transmission cost and the packet processing cost for communicating the device data associated with the industrial device to the cloud platform may be reduced.

Similarly, as described herein, the edge device may receive the third packet associated with the second communication protocol from the TMMS on the cloud platform, and determine the operation to be performed by the industrial device that is indicated in the third packet. The edge device may then determine the plurality of device commands to be executed by the industrial device to perform the operation, create the plurality of fourth packets associated with the first communication protocol that specify the plurality of device commands to be executed by the industrial device, and transmit the plurality of fourth packets to the industrial device. Thus, for one third packet transmitted from the TMMS on the cloud platform that indicates the operation to be performed by the industrial device, the edge device may create multiple fourth packets specifying multiple device commands to be executed by the industrial device to perform the operation, and transmit the multiple fourth packets to the industrial device. Accordingly, the number of packets being transmitted from the cloud platform to cause the industrial device to perform the operation may be minimized to one third packet, and thus the transmission cost and the packet processing cost associated with such communication may be reduced. As described herein, other implementations for causing the industrial device to perform the operation in response to one third packet being transmitted from the TMMS on the cloud platform are also possible and contemplated.

In addition, as described herein, the edge device may receive the plurality of first packets associated with the first communication protocol, in which the plurality of first packets are transmitted from the industrial device to the edge device in accordance with the first communication protocol (e.g., the CIP protocol). The edge device may then create the second packet associated with the second communication protocol based on the plurality of first packets, and transmit the second packet associated with the second communication protocol to the cloud platform in accordance with the second communication protocol (e.g., the MQTT protocol). Additionally, as described herein, the edge device may receive the third packet associated with the second communication protocol, in which the third packet is transmitted from the cloud platform to the edge device in accordance with the second communication protocol (e.g., the MQTT protocol). The edge device may then create the plurality of fourth packets associated with the first communication protocol based on the third packet, and transmit the plurality of fourth packets associated with the first communication protocol to the industrial device in accordance with the first communication protocol (e.g., the CIP protocol). Thus, the edge device and the industrial device may communicate with one another using the first communication protocol in which the first communication protocol may be the low-latency high-speed communication protocol (e.g., the CIP protocol). On the other hand, the edge device and the cloud platform may communicate with one another using the second communication protocol in which the second communication protocol may be the high-latency low-speed communication protocol (e.g., the MQTT protocol). As the low-latency high-speed communication protocol (e.g., the CIP protocol) may be implemented for the communication between the edge device and the industrial device with a relatively large number of packets being transmitted between the edge device and the industrial device, while the high-latency low-speed communication protocol (e.g., the MQTT protocol) may be implemented for the communication between the edge device and the cloud platform with a lower number of packets being transmitted between the edge device and the cloud platform, the overall efficiency of the communication between the industrial device, the edge device, and the cloud platform may be improved.

Various illustrative embodiments will now be described in detail with reference to the figures. It should be understood that the illustrative embodiments described below are provided as examples and that other examples not explicitly described herein may also be captured by the scope of the claims set forth below. The systems and methods described herein may provide any of the benefits mentioned above, as well as various additional and/or alternative benefits that will be described and/or made apparent below.

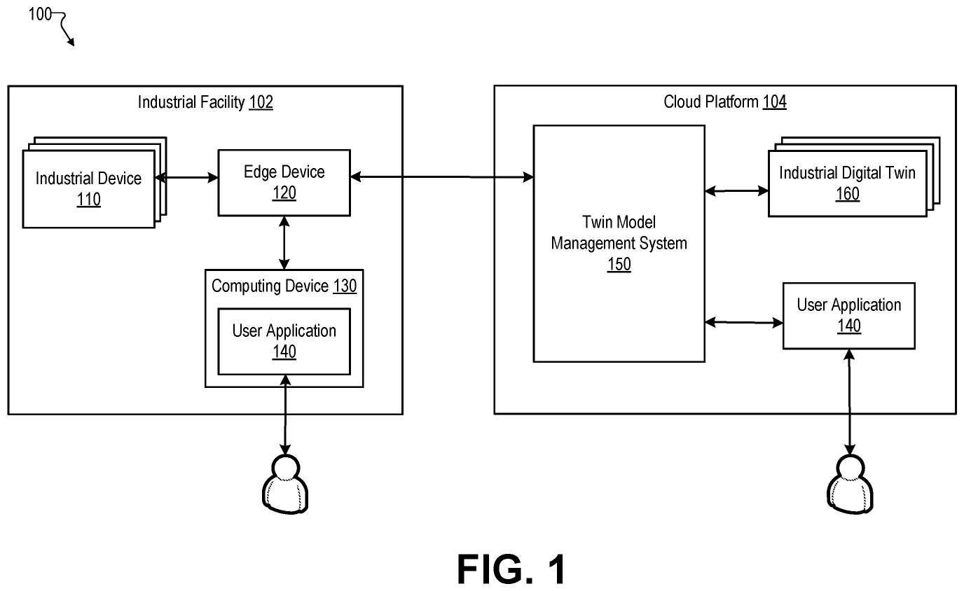

FIG. 1 illustrates an example system 100 for managing an industrial digital twin and controlling an industrial device. As depicted in FIG. 1, the system 100 may include an industrial facility 102 and a cloud platform 104.

In some embodiments, the industrial facility 102 may be a physical environment in which one or more industrial operations are performed. As depicted in FIG. 1, the industrial facility 102 may include one or more industrial devices 110, an edge device 120, and a computing device 130. Other devices and systems in the industrial facility 102 are also possible and contemplated.

In some embodiments, an industrial device 110 may perform various operations and/or functionalities in the industrial facility 102. For example, the industrial device 110 may be included in one or more industrial systems that carry out one or more industrial processes. Non-limiting examples of the industrial device 110 include, but are not limited to, an industrial controller (e.g., programmable automation controller such as programmable logic controller (PLC), etc.), a field device (e.g., a sensor, a meter, an Internet of Things (IoT) device, etc.), a motion control device (e.g., a motor drive, etc.), an operator interface device (e.g., a human-machine interface device, an industrial monitor, a graphic terminal, a message display device, etc.), an industrial automated machine (e.g., an industrial robot, etc.), a lot control system (e.g., a barcode marker, a barcode reader, etc.), a vision system device (e.g., a vision camera, etc.), a safety relay, an optical safety system, etc. Other types of industrial device are also possible and contemplated.

In some embodiments, the industrial device 110 may communicate with other devices (e.g., the edge device 120, other industrial devices 110, etc.) in the industrial facility 102 using a first communication protocol. The first communication protocol may be a low-latency high-speed communication protocol that has a relatively small packet size with a relatively simple packet header to reduce the transmission time and the packet processing time. Accordingly, the first communication protocol may enable fast communication between the industrial device 110 and other devices in the industrial facility 102. Non-limiting examples of the first communication protocol include, but are not limited to, Common Industrial Protocol (also referred to herein as the CIP protocol), EtherCAT protocol, Profinet protocol, Modbus protocol, etc. Other types of low-latency high-speed communication protocol are also possible and contemplated.

As an example, the first communication protocol implemented by the industrial device 110 may be the CIP protocol. In this case, the industrial device 110 may implement one or more Common Industrial Protocol (CIP) objects in which each CIP object may include one or more data attributes, one or more services (e.g., commands), one or more behaviors (e.g., relationships between values of the data attributes and the services), and/or other components that can be used to control or manage various functionalities and/or operations of the industrial device 110. In some embodiments, the industrial device 110 that implements the CIP protocol and operates using the CIP protocol may be referred to as a CIP device.

In some embodiments, the industrial device 110 may transmit device data associated with the industrial device 110 to the edge device 120. For example, the industrial device 110 may transmit its device data to the edge device 120 at a predefined interval (e.g., every 2s). Additionally or alternatively, when the device data associated with the industrial device 110 is generated or determined (e.g., when a sensor value is measured by a sensor of the industrial device 110), the industrial device 110 may transmit such device data to the edge device 120 in real-time or near real-time. In some embodiments, the device data associated with the industrial device 110 may include, but is not limited to, a device parameter of the industrial device 110, a sensor value generated by a sensor of the industrial device 110, a component status of a component in the industrial device 110, a performance metric of the industrial device 110, a device configuration of the industrial device 110, a value of a process variable associated with an industrial process in which the industrial device 110 participates, etc. In some embodiments, the industrial device 110 may be a CIP device that implements the CIP protocol as described above. In this case, the data attributes of one or more CIP objects implemented by the industrial device 110 may indicate the device data associated with the industrial device 110. The device data associated with the industrial device 110 may also be referred to herein as the device data of the industrial device 110.

In some embodiments, the edge device 120 may be located within the industrial facility 102 and may facilitate the communication between the industrial devices 110 in the industrial facility 102 and the cloud platform 104. As an example, the edge device 120 may be a gateway device that operates at the edge of an industrial network implemented in the industrial facility 102. Additionally or alternatively, the edge device 120 may operate as a broker device (e.g., an MQTT broker) in a communication system.

In some embodiments, the edge device 120 may collect data from the industrial devices 110 and/or other data sources (e.g., a local data store, an on-premises processing system, etc.) and transmit the collected data to the cloud platform 104 for industrial digital twin update, data processing, data analytic, and/or data storage. For example, the edge device 120 may receive the device data associated with the industrial device 110 from the industrial device 110, and transmit the device data associated with the industrial device 110 to a twin model management system (TMMS) 150 on the cloud platform 104. In some embodiments, the edge device 120 may transmit the device data associated with the industrial device 110 to the TMMS 150 at a predefined interval (e.g., every 3s). Additionally or alternatively, when the edge device 120 receives the device data associated with the industrial device 110, the edge device 120 may transmit the device data associated with the industrial device 110 to the TMMS 150 in real-time or near real-time. In this present disclosure, when the edge device 120 communicates with the cloud platform 104, the edge device 120 may communicate with the TMMS 150 implemented on the cloud platform 104. However, it should be understood that the edge device 120 may communicate with other systems implemented on the cloud platform 104 in a similar manner or in a different manner to perform other operations.

In some embodiments, the edge device 120 may communicate with the industrial devices 110 in the first communication protocol (e.g., the CIP protocol) and communicate with the cloud platform 104 in a second communication protocol (e.g., the MQTT protocol) that is different from the first communication protocol. As described herein, the first communication protocol may be a low-latency high-speed communication protocol that has a relatively small packet size and a relatively simple packet header (e.g., the packet header may include a relatively low number of fields) to reduce the transmission time and the packet processing time, and therefore the first communication protocol may facilitate fast communication. On the other hand, the second communication protocol may be a high-latency low-speed communication protocol that has a relatively large packet size and a relatively complicated packet header (e.g., the packet header may include a relatively high number of fields), and therefore the second communication protocol may not facilitate fast communication.

In some embodiments, the first communication protocol may be considered a low-latency high-speed communication protocol and the second communication protocol may be considered a high-latency low-speed communication protocol relative to one another. For example, the first communication protocol may have a maximum packet size associated with the first communication protocol (e.g., 500 bytes) lower than a maximum packet size associated with the second communication protocol (e.g., 256 MB). Additionally or alternatively, a packet header of a packet that conforms to the first communication protocol may have a lower number of fields as compared to a packet header of a packet that conforms to the second communication protocol. Accordingly, the first communication protocol may better facilitate fast packet transmission and fast packet processing as compared to the second communication protocol. As a result, an amount of time to communicate a given data item in accordance with the first communication protocol from a particular source to a particular destination may be lower than an amount of time to communicate the given data item in accordance with the second communication protocol from the particular source to the particular destination in a similar network condition. Non-limiting examples of the first communication protocol include, but are not limited to, Common Industrial Protocol (also referred to herein as the CIP protocol), EtherCAT protocol, Profinet protocol, Modbus protocol, etc. Non-limiting examples of the second communication protocol include, but are not limited to, Message Queuing Telemetry Transport protocol (also referred to herein as the MQTT protocol), Advanced Message Queuing Protocol (AMQP), Kafka protocol, Open Platform Communication-Unified Architecture (OPC-UA) protocol, etc. It should be understood that other low-latency high-speed communication protocols may also be used as the first communication protocol, and other high-latency low-speed communication protocols may also be used as the second communication protocol.

In some embodiments, the computing device 130 may be located within the industrial facility 102 and may be used to control or manage the industrial devices 110 in the industrial facility 102. For example, as depicted in FIG. 1, the computing device 130 may include a user application 140 that provides a user interface through which a user may control or manage the operations of various industrial devices 110 in the industrial facility 102. Non-limiting examples of the computing device 130 include, but are not limited to, a desktop computer, a laptop computer, a tablet device, a mobile phone, a wearable headset device, etc. Other types of computing device are also possible and contemplated. In some embodiments, the computing device 130 may communicate with the industrial devices 110 via the edge device 120 as depicted in FIG. 1. In some embodiments, the functionalities of the computing device 130 may be included in the edge device 120, and thus the edge device 120 may perform one or more operations of the computing device 130 described herein.

In some embodiments, the cloud platform 104 may provide various cloud-based services (e.g., data analytics, visualization, data storage, supervisory control, etc.) for the industrial devices 110 and/or the industrial systems implemented in the industrial facility 102. In some embodiments, the cloud platform 104 may be a public cloud in which the cloud-based services are provided by a cloud service provider and are accessible through a public network (e.g., the Internet) upon subscription to the cloud-based services. Alternatively, the cloud platform 104 may be a semi-private cloud in a shared cloud environment or in a corporate cloud environment. Alternatively, the cloud platform 104 may be a private cloud operated internally by an industrial enterprise that includes the industrial facility 102. For example, the private cloud may include one or more computing devices (e.g., physical or virtual servers) that host the cloud-based services and reside within a corporate network protected by a firewall.

In some embodiments, the cloud platform 104 may implement one or more computing systems and/or one or more applications to provide the cloud-based services and facilitate the control and management of the industrial devices 110 and/or the industrial systems in the industrial facility 102. For example, as depicted in FIG. 1, the cloud platform 104 may include the twin model management system (TMMS) 150, one or more industrial digital twins 160, and the user application 140. Other systems, applications, and/or models may also be implemented on the cloud platform 104.

In some embodiments, the TMMS 150 may be a cloud-based computing system that manages the industrial digital twins 160 and facilitates the user in controlling the industrial devices 110 in the industrial facility 102. The TMMS 150 may reside on the cloud platform 104 and may be implemented by computing resources such as servers, processors, memory devices, storage devices, communication interfaces, and/or other computing resources. In some embodiments, various components of the system 100 may collaborate with one another to perform one or more operations of the TMMS 150 described herein.

In some embodiments, one or more industrial digital twins 160 may be implemented on the cloud platform 104. As an example, an industrial digital twin 160 among the industrial digital twins 160 may be a virtual model of an industrial device 110 (e.g., a motor drive) and may dynamically reflect the industrial device 110 in real-time or near real-time. In this case, the industrial digital twin 160 may be referred to as the industrial digital twin of the industrial device 110 or the device twin of the industrial device 110. As another example, an industrial digital twin 160 among the industrial digital twins 160 may be a virtual model of an industrial system (e.g., a workstation, a manufacturing line, the entire industrial facility, etc.) that includes various industrial devices 110 in the industrial facility 102. The industrial digital twin 160 may include virtual representations of the industrial devices 110 in the industrial system and may dynamically reflect the industrial system in real-time or near real-time. In this case, the industrial digital twin 160 may be referred to as the industrial digital twin of the industrial system or the system twin of the industrial system.

In some embodiments, for each industrial device 110 in the industrial facility 102, the TMMS 150 may frequently receive the device data associated with the industrial device 110 from the edge device 120 as described herein. The TMMS 150 may analyze the device data associated with the industrial device 110 and use this device data to update one or more industrial digital twins 160 (e.g., the industrial digital twin of the industrial device 110, the industrial digital twin of the industrial system that includes the industrial device 110, etc.) if needed to synchronize the industrial digital twins 160 with the industrial device 110. Accordingly, the industrial digital twin of the industrial device 110 may reflect the operations, the component statuses, and/or other aspects of the industrial device 110, and therefore the industrial digital twin of the industrial device 110 may be considered a dynamic virtual model of the industrial device 110 that indicates the behaviors, the operation state, and/or other aspects of the industrial device 110 in real-time or near real-time. Similarly, the industrial digital twin of the industrial system that includes the industrial device 110 may be considered a dynamic virtual model of the industrial system in which the information associated with the virtual representation of the industrial device 110 in the industrial digital twin of the industrial system may indicate the behaviors, the operation state, and/or other aspects of the industrial device 110 in real-time or near real-time.

In some embodiments, the industrial digital twin 160 (e.g., the industrial digital twin of the industrial device 110, the industrial digital twin of the industrial system that includes the industrial device 110, etc.) may implement a simulation algorithm and the simulation algorithm may simulate the operations of the industrial device 110 given the device configurations and the working conditions of the industrial device 110. As a result of such simulation, the industrial digital twin 160 may generate simulation data associated with the industrial device 110. In some embodiments, the simulation data associated with the industrial device 110 may indicate simulated values of the device parameters, the performance metrics, the component status, and/or other information that are predicted for the industrial device 110 given the operations of the industrial device 110 in the particular context of the industrial device 110. In some embodiments, based on the simulation data associated with the industrial device 110 that is generated by the industrial digital twin 160 and based on the device data associated with the industrial device 110 that is provided by the industrial device 110 and received from the edge device 120, the TMMS 150 may update the industrial digital twin 160 based on the device data associated with the industrial device 110 or adjust one or more operations of the industrial device 110 to reduce or address the difference between the simulation data associated with the industrial device 110 and the device data associated with the industrial device 110, if any.

In some embodiments, the user application 140 may be a cloud-based application that provides a user interface through which a user may interact with various components of the system 100. In some embodiments, the user application 140 may be capable of performing the operations of the user application 140 implemented on the computing device 130 and also capable of performing other operations.

In some embodiments, the user may provide a user request via the user application 140. The TMMS 150 may receive the user request, and perform one or more operations to carry out the user request. As an example, the user may provide via the user application 140 a user request to view simulation data associated with an industrial device 110 that is generated by the industrial digital twin 160. In response to this user request, the TMMS 150 may obtain the simulation data associated with the industrial device 110 that is generated by the industrial digital twin 160, and present the simulation data associated with the industrial device 110 to the user via the user application 140. As another example, the user may provide via the user application 140 a user request to synchronize the industrial digital twin 160 with the industrial device 110. In response to this user request, the TMMS 150 may update the industrial digital twin 160 using the device data associated with the industrial device 110, thereby synchronizing the industrial digital twin 160 with the industrial device 110. As another example, the user may provide via the user application 140 a user request that specifies an operation to be performed by the industrial device 110. In response to this user request, the TMMS 150 may communicate and collaborate with the edge device 120 in instructing the industrial device 110 to execute one or more device commands to perform the operation indicated in the user request. In some embodiments, the TMMS 150 and the edge device 120 may communicate with one another using the second communication protocol (e.g., the MQTT protocol) that is the high-latency low-speed communication protocol as described herein.

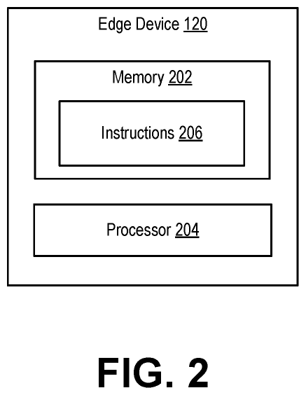

FIG. 2 illustrates an example edge device 120 that can be used to facilitate the management of the industrial digital twins 160 and facilitate the control of the industrial devices 110. In some embodiments, the edge device 120 may be implemented by computing resources such as servers, processors, memory devices, storage devices, communication interfaces, and/or other computing resources. In some embodiments, the edge device 120 may be a computing device located in the industrial facility 102. In some embodiments, various components of the system 100 may collaborate with one another to perform one or more operations of the edge device 120. In some embodiments, the operations of the edge device 120 may be controlled and/or managed by a management system implemented by the edge device 120. The management system may be implemented in the form of a software component (e.g., a containerized application), a hardware component, and/or a combination thereof. In some embodiments, the management system may be implemented on the edge device 120. Additionally or alternatively, the management system may be implemented on a different computing system (e.g., a local server, a remote server, a cloud platform, etc.) and may be communicatively coupled to the edge device 120 to provide instructions and/or commands to the edge device 120. Other implementations of the edge device 120 are also possible and contemplated.

As depicted in FIG. 2, the edge device 120 may include, without limitation, a memory 202 and a processor 204 communicatively coupled to one another. The memory 202 and the processor 204 may each include or be implemented by computer hardware that is configured to store and/or execute computer software. Other components of computer hardware and/or software not explicitly shown in FIG. 2 may also be included within the edge device 120. In some embodiments, the memory 202 and the processor 204 may be distributed between multiple devices and/or multiple locations as may serve a particular implementation.

The memory 202 may store and/or otherwise maintain executable data used by the processor 204 to perform one or more functionalities of the edge device 120 described herein. For example, the memory 202 may store instructions 206 that may be executed by the processor 204. In some embodiments, the memory 202 may be implemented by one or more memory or storage devices, including any memory or storage devices described herein, that are configured to store data in a transitory or non-transitory manner. In some embodiments, the instructions 206 may be executed by the processor 204 to cause the edge device 120 to perform one or more functionalities described herein. The instructions 206 may be implemented by any suitable application, software, code, and/or other executable data instance. Additionally, the memory 202 may also maintain any other data accessed, managed, used, and/or transmitted by the processor 204 in a particular implementation.

The processor 204 may be implemented by one or more computer processing devices, including general purpose processors (e.g., central processing units (CPUs), graphics processing units (GPUs), microprocessors, etc.), special purpose processors (e.g., application specific integrated circuits (ASICs), field-programmable gate arrays (FPGAs), etc.), or the like. The edge device 120 may use the processor 204 (e.g., when the processor 204 is directed to perform operations represented by instructions 206 stored in the memory 202) and perform various functionalities associated with digital twin management and device control in any manner described herein or as may serve a particular implementation.

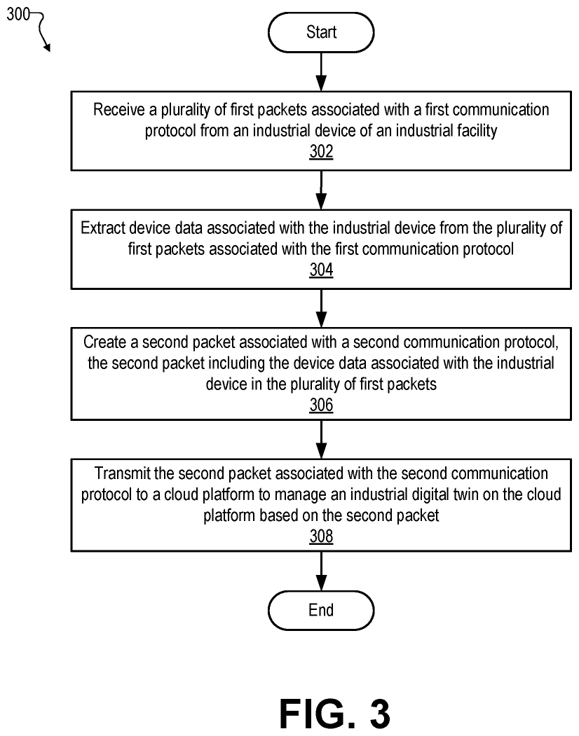

FIG. 3 illustrates an example method 300 for managing an industrial digital twin using an edge device. While FIG. 3 shows illustrative operations according to one embodiment, other embodiments may omit, add to, reorder, and/or modify any of the operations shown in FIG. 3. In some examples, multiple operations shown in FIG. 3 or described in relation to FIG. 3 may be performed concurrently (e.g., in parallel) with one another, rather than being performed sequentially as illustrated and/or described. One or more of the operations shown in FIG. 3 may be performed by an edge device of an industrial facility such as the edge device 120 and/or any implementation thereof.

At operation 302, the edge device 120 may receive a plurality of first packets associated with a first communication protocol from an industrial device 110 (e.g., a motor drive) of the industrial facility 102. As described herein, the first communication protocol may be a low-latency high-speed communication protocol such as the CIP protocol.

At operation 304, the edge device 120 may extract device data associated with the industrial device 110 from the plurality of first packets associated with the first communication protocol. The device data associated with the industrial device 110 may be generated and/or determined by the industrial device 110 and may include various data (e.g., the device parameters, the sensor values, the performance metrics, the device configurations, etc.) that describes the operations and other aspects of the industrial device 110.

At operation 306, the edge device 120 may create a second packet associated with a second communication protocol, in which the second packet may include the device data associated with the industrial device 110 in the plurality of first packets. As described herein, the second communication protocol may be different from the first communication protocol and may be a high-latency low-speed communication protocol such as the MQTT protocol. Thus, the edge device 120 may aggregate the device data associated with the industrial device 110 in the plurality of first packets that conform to the first communication protocol (e.g., the CIP protocol) to create one second packet that conforms to the second communication protocol (e.g., the MQTT protocol).

At operation 308, the edge device 120 may transmit the second packet associated with the second communication protocol to the cloud platform 104 to manage an industrial digital twin 160 on the cloud platform 104 based on the second packet. For example, the edge device 120 may transmit the second packet to the cloud platform 104 in accordance with the second communication protocol (e.g., the MQTT protocol). When receiving the second packet associated with the second communication protocol from the edge device 120, the cloud platform 104 (e.g., the TMMS 150 on the cloud platform 104) may obtain the device data associated with the industrial device 110 included in the second packet, and use the device data associated with the industrial device 110 to manage the industrial digital twin 160. In some embodiments, the industrial digital twin 160 may be an industrial digital twin of the industrial device 110 or an industrial digital twin of an industrial system (e.g., a manufacturing line) that includes the industrial device 110. Based on the device data associated with the industrial device 110, the TMMS 150 may determine whether the industrial device 110 and the industrial digital twin 160 drift apart from one another. Additionally or alternatively, the TMMS 150 may update the industrial digital twin 160 using the device data associated with the industrial device 110 to synchronize the industrial digital twin 160 with the industrial device 110. The device data associated with the industrial device 110 may also be used in other operations to manage the industrial digital twin 160 and/or manage the industrial device 110 as described herein. In some embodiments, the device data associated with the industrial device 110 may also be used in data analytics, system monitoring, and/or other operations being performed on the cloud platform 104.

Thus, as described above, the edge device 120 may facilitate the communication of the device data associated with the industrial device 110 to the cloud platform 104. In particular, the edge device 120 may receive the plurality of first packets associated with the first communication protocol from the industrial device 110. As described herein, the plurality of first packets may include the device data (e.g., the device parameters, the sensor values, the performance metrics, the device configurations, etc.) associated with the industrial device 110 that is determined and/or generated by the industrial device 110. In some embodiments, each first packet among the plurality of first packets may conform to the packet format of the first communication protocol, and the industrial device 110 may transmit the first packet to the edge device 120 in accordance with the first communication protocol. As described herein, the first communication protocol may be a low-latency high-speed communication protocol such as the CIP protocol. Other types of low-latency high-speed communication protocol are also possible and contemplated.

In some embodiments, when receiving the plurality of first packets from the industrial device 110 in the first communication protocol, the edge device 120 may extract the device data associated with the industrial device 110 from the plurality of first packets. For example, for each first packet among the plurality of first packets, the edge device 120 may analyze the first packet to obtain the device data associated with the industrial device 110 in the payload of the first packet. In some embodiments, the edge device 120 may also obtain the metadata of the first packet. The metadata of the first packet may include the packet identifier (ID) of the first packet, the packet size of the first packet, the device ID of the industrial device 110 that transmits the first packet, etc. Other types of metadata of the first packet are also possible and contemplated.

In some embodiments, based on the device data associated with the industrial device 110 that is provided by the industrial device 110 in the plurality of first packets, the edge device 120 may create the second packet associated with the second communication protocol. The second packet may conform to the packet format of the second communication protocol and may include the device data associated with the industrial device 110 in the plurality of first packets. As described herein, the second communication protocol may be different from the first communication protocol and may be a high-latency low-speed communication protocol such as the MQTT protocol. Other types of high-latency low-speed communication protocol are also possible and contemplated.

In some embodiments, to create the second packet associated with the second communication protocol, the edge device 120 may aggregate the device data associated with the industrial device 110 in the plurality of first packets to form the data of the second packet. The edge device 120 may also generate the metadata for the second packet, in which for each first packet among the plurality of first packets, the metadata may indicate a portion within the data of the second packet that corresponds to the first packet.

As an example, for each first packet among the plurality of first packets, the edge device 120 may create a data object corresponding to the first packet that contains the device data associated with the industrial device 110 in the first packet. The edge device 120 may then aggregate these data objects into a sequence of data objects, and include the sequence of data objects in the payload of the second packet as the data of the second packet. In some embodiments, for each data object that corresponds to a first packet among the plurality of first packets, the edge device 120 may create object metadata for the data object. The object metadata of the data object may indicate the packet ID of the first packet, the packet size of the first packet, the device ID of the industrial device 110 that transmits the first packet, and/or other metadata of the first packet to which the data object corresponds.

In some embodiments, the object metadata of the data object may be associated with the data object in the second packet. For example, the edge device 120 may include the object metadata of the data object in the second packet at a position preceding the data object without other data being placed in between. Additionally or alternatively, the edge device 120 may include the object metadata of the data object within the data object as part of the data object. Additionally or alternatively, the edge device 120 may aggregate the object metadata of various data objects into a list of object metadata, in which each item in the list of object metadata is the object metadata of a data object in the sequence of data objects and is mapped to the data object in the sequence of data objects. In some embodiments, the metadata of the second packet may include the object metadata of multiple data objects in the second packet and may also include other types of metadata associated with the second packet such as the packet ID of the second packet, the packet size of the second packet, etc.

As another example, the edge device 120 may aggregate the device data associated with the industrial device 110 in the plurality of first packets into a binary sequence, and include the binary sequence in the payload of the second packet as the data of the second packet. The binary sequence may include multiple data segments, in which each data segment in the binary sequence may correspond to a first packet among the plurality of first packets and may contain the device data associated with the industrial device 110 in the first packet. In some embodiments, for each data segment that corresponds to a first packet among the plurality of first packets, the edge device 120 may create segment metadata for the data segment. The segment metadata of the data segment may indicate the start point and the end point of the data segment within the binary sequence. The segment metadata of the data segment may also indicate the packet ID of the first packet, the packet size of the first packet, the device ID of the industrial device 110 that transmits the first packet, and/or other metadata of the first packet to which the data segment corresponds.

In some embodiments, the segment metadata of the data segment may be associated with the data segment in the second packet. For example, the edge device 120 may include the segment metadata of the data segment in the second packet at a position preceding the data segment without other data being placed therebetween. Additionally or alternatively, the edge device 120 may aggregate the segment metadata of various data segments into a list of segment metadata, in which each item in the list of segment metadata is the segment metadata of a data segment in the binary sequence and is mapped to the data segment in the binary sequence. In some embodiments, the metadata of the second packet may include the segment metadata of multiple data segments in the second packet and may also include other types of metadata associated with the second packet such as the packet ID of the second packet, the packet size of the second packet, etc.

Thus, as described above, the edge device 120 may receive the plurality of first packets from the industrial device 110, and create one second packet that includes the device data associated with the industrial device 110 in the plurality of first packets. The edge device 120 may then transmit the second packet to the TMMS 150 on the cloud platform 104. Accordingly, the number of packets being transmitted to the cloud platform 104 may be significantly decreased, and thus the transmission cost and the packet processing cost for communicating the device data associated with the industrial device 110 to the cloud platform 104 may be reduced.

In addition, as described herein, the plurality of first packets may be associated with the first communication protocol, and the industrial device 110 may transmit the plurality of first packets to the edge device 120 in accordance with the first communication protocol (e.g., the CIP protocol). On the other hand, the second packet may be associated with the second communication protocol, and the edge device 120 may transmit the second packet to the TMMS 150 on the cloud platform 104 in accordance with the second communication protocol (e.g., the MQTT protocol). As described herein, the first communication protocol may be the low-latency high-speed communication protocol, and the second communication protocol may be the high-latency low-speed communication protocol. Thus, the first communication protocol that is the low-latency high-speed communication protocol (e.g., the CIP protocol) may be used for the communication between the industrial device 110 and the edge device 120 in which a relatively large number of packets are transmitted between the industrial device 110 and the edge device 120. On the other hand, the second communication protocol that is the high-latency low-speed communication protocol (e.g., the MQTT protocol) may be used for the communication between the edge device 120 and the TMMS 150 on the cloud platform 104 in which a lower number of packets are transmitted between the edge device 120 and the cloud platform 104. As a result of this implementation, the overall efficiency in communication between the industrial device 110, the edge device 120, and the cloud platform 104 may be improved.

In some embodiments, instead of creating the second packet that includes the device data of one industrial device 110 in the plurality of first packets received from the industrial device 110, the edge device 120 may create the second packet that includes the device data of various industrial devices 110 in multiple packets that are received from various industrial devices 110. In some embodiments, the edge device 120 may create the second packet that includes the device data of various industrial devices 110 in a manner similar to the manner in which the second packet that includes the device data of one industrial device 110 is created as described above.

For example, the edge device 120 may receive a plurality of particular packets associated with the first communication protocol from a particular industrial device 110, and extract device data associated with the particular industrial device 110 from the particular packets. The edge device 120 may also receive a plurality of different packets associated with the first communication protocol from a different industrial device 110, and extract device data associated with the different industrial device 110 from the different packets. In some embodiments, the different industrial device 110 may be distinct from the particular industrial device 110. In some embodiments, the particular industrial device 110 and the different industrial device 110 may work with one another. For example, the particular industrial device 110 and the different industrial device 110 may collaborate with one another in an industrial process or may be part of the same industrial system (e.g., a workstation or a manufacturing line). As another example, an output of the particular industrial device 110 may be provided as an input to the different industrial device 110 or vice versa.

In some embodiments, the edge device 120 may aggregate the device data associated with the particular industrial device 110 in the particular packets received from the particular industrial device 110 and the device data associated with the different industrial device 110 in the different packets received from the different industrial device 110 to form the data of the second packet. The edge device 120 may also generate the metadata for the second packet, in which for each given packet among the particular packets received from the particular industrial device 110 and the different packets received from the different industrial device 110, the metadata may indicate a portion within the data of the second packet that corresponds to the given packet.

As an example, for each given packet among the particular packets received from the particular industrial device 110 and the different packets received from the different industrial device 110, the edge device 120 may create a data object corresponding to the given packet that contains the device data associated with the particular industrial device 110 or the device data associated with the different industrial device 110 in the given packet. The edge device 120 may then aggregate these data objects into a sequence of data objects, and include the sequence of data objects in the payload of the second packet as the data of the second packet. In some embodiments, for each data object that corresponds to a given packet among the particular packets received from the particular industrial device 110 and the different packets received from the different industrial device 110, the edge device 120 may create object metadata for the data object. The object metadata may be associated with the data object in the second packet and may indicate the packet ID of the given packet, the packet size of the given packet, the device ID of the particular industrial device 110 or the different industrial device 110 that transmits the given packet, and/or other metadata of the given packet to which the data object corresponds.

As another example, the edge device 120 may aggregate the device data associated with the particular industrial device 110 in the particular packets received from the particular industrial device 110 and the device data associated with the different industrial device 110 in the different packets received from the different industrial device 110 into a binary sequence, and include the binary sequence in the payload of the second packet as the data of the second packet. The binary sequence may include multiple data segments, in which each data segment in the binary sequence may correspond to a given packet among the particular packets received from the particular industrial device 110 and the different packets received from the different industrial device 110. The data segment corresponding to the given packet may contain the device data associated with the particular industrial device 110 or the device data associated with the different industrial device 110 in the given packet. In some embodiments, for the data segment corresponding to the given packet, the edge device 120 may create segment metadata for the data segment. The segment metadata may be associated with the data segment and may indicate the start point and the end point of the data segment within the binary sequence. The segment metadata of the data segment may also indicate the packet ID of the given packet, the packet size of the given packet, the device ID of the particular industrial device 110 or the different industrial device 110 that transmits the given packet, and/or other metadata of the given packet to which the data segment corresponds.

Thus, as described above, the edge device 120 may receive multiple packets from various industrial devices 110, and create one second packet that includes the device data of various industrial devices 110 in these multiple packets. The edge device 120 may then transmit the second packet to the TMMS 150 on the cloud platform 104. Accordingly, the device data of different industrial devices 110 may be transmitted to the cloud platform 104 in the same second packet and such device data may be used to manage (e.g., evaluate, update, etc.) different industrial digital twins of different industrial devices 110 and/or to manage (e.g., evaluate, update, etc.) the information associated with different visual representations of different industrial devices 110 in an industrial digital twin of an industrial system (e.g., a manufacturing line) that includes these industrial devices 110.

In some embodiments, the edge device 120 may transmit the second packet associated with the second communication protocol to the cloud platform 104 in accordance with the second communication protocol (e.g., the MQTT protocol). For example, the edge device 120 may transmit the second packet associated with the second communication protocol to the TMMS 150 implemented on the cloud platform 104, and thus the TMMS 150 may receive the second packet associated with the second communication protocol from the edge device 120. As described herein, the second packet may include the device data associated with the industrial device 110 that is provided by the industrial device 110 in the plurality of first packets.

In some embodiments, the TMMS 150 may extract the device data associated with the industrial device 110 from the second packet based on the metadata of the second packet. For example, the TMMS 150 may identify each data object in the data of the second packet based on the object metadata of the data object in the metadata of the second packet. Based on the object metadata of the data object, the TMMS 150 may also identify the industrial device 110 that transmits the first packet corresponding to the data object and obtain the device data associated with the industrial device 110 in the first packet that is contained in the data object. Alternatively, the TMMS 150 may identify each data segment in the data of the second packet based on the segment metadata of the data segment in the metadata of the second packet. Based on the segment metadata of the data segment, the TMMS 150 may also identify the industrial device 110 that transmits the first packet corresponding to the data segment and obtain the device data associated with the industrial device 110 in the first packet that is contained in the data segment. Thus, the TMMS 150 may obtain the device data associated with the industrial device 110 that is provided by the industrial device 110 in the plurality of first packets and transmitted to the TMMS 150 by the edge device 120 in one second packet.

In some embodiments, the TMMS 150 may compare the device data associated with the industrial device 110 that is provided by the industrial device 110 and extracted from the second packet to simulation data associated with the industrial device 110 that is generated by an industrial digital twin 160. The industrial digital twin 160 may be the industrial digital twin of the industrial device 110 or the industrial digital twin of the industrial system (e.g., the manufacturing line) that includes the industrial device 110. As described herein, the industrial digital twin 160 may implement a simulation algorithm and the simulation algorithm may generate the simulation data associated with the industrial device 110 when being executed. In some embodiments, the simulation data associated with the industrial device 110 may indicate simulated values of the device parameters, the performance metrics, the component status, and/or other information that are predicted for the industrial device 110 by the industrial digital twin 160 using the simulation algorithm. In some embodiments, when comparing the device data associated with the industrial device 110 to the simulation data associated with the industrial device 110, the TMMS 150 may determine that the device data associated with the industrial device 110 that is provided by the industrial device 110 and extracted from the second packet matches the simulation data associated with the industrial device 110 that is generated by the industrial digital twin 160. In this case, the TMMS 150 may determine that there is no difference between the actual operations of the industrial device 110 in the industrial facility 102 and the simulated operations of the industrial device 110 as indicated by the industrial digital twin 160 on the cloud platform 104. Accordingly, the TMMS 150 may determine that the industrial device 110 in the industrial facility 102 and the industrial digital twin 160 on the cloud platform 104 are in synchronization, and therefore the industrial digital twin 160 does not need to be updated.

On the other hand, when comparing the device data associated with the industrial device 110 to the simulation data associated with the industrial device 110, the TMMS 150 may determine that the device data associated with the industrial device 110 that is provided by the industrial device 110 and extracted from the second packet does not match the simulation data associated with the industrial device 110 that is generated by the industrial digital twin 160. For example, based on the comparison, the TMMS 150 may determine that an actual value of a particular parameter in the device data associated with the industrial device 110 is different from a simulated value of the particular parameter in the simulation data associated with the industrial device 110 generated by the industrial digital twin 160. In this case, the TMMS 150 may determine that the actual operations of the industrial device 110 in the industrial facility 102 and the simulated operations of the industrial device 110 as indicated by the industrial digital twin 160 on the cloud platform 104 are different from one another in one or more aspects. Accordingly, the TMMS 150 may determine that the industrial device 110 and the industrial digital twin 160 have drifted apart from one another with the actual value of the particular parameter in the device data associated with the industrial device 110 being different from the simulated value of the particular parameter in the simulation data associated with the industrial device 110 generated by the industrial digital twin 160. In response to such determination, the TMMS 150 may provide a notification to a user indicating that the actual value of the particular parameter is different from the simulated value of the particular parameter generated by the industrial digital twin 160.

In some embodiments, in response to the notification, the user may evaluate the difference between the actual value of the particular parameter that is provided by the industrial device 110 and transmitted to the TMMS 150 in the second packet and the simulated value of the particular parameter that is generated by the industrial digital twin 160. The user may also inspect the industrial device 110. As a result of such evaluation and/or inspection, the user may determine that the industrial device 110 is operating as expected. In this case, the user may provide a user request to synchronize the industrial digital twin 160 with the industrial device 110. The user request may be provided via the user application 140 and the TMMS 150 may receive the user request. In some embodiments, in response to the user request, the TMMS 150 may update the simulated value of the particular parameter in the industrial digital twin 160 to be equal to the actual value of the particular parameter in the device data associated with the industrial device 110, thereby synchronizing the industrial digital twin 160 with the industrial device 110. As a result of such synchronization, the industrial digital twin 160 implemented on the cloud platform 104 may accurately reflect the actual operations of the industrial device 110 in the industrial facility 102.

Alternatively, based on the evaluation of the difference between the actual value of the particular parameter and the simulated value of the particular parameter and/or based on the inspection of the industrial device 110, the user may determine that the industrial device 110 is not operating as expected. In this case, the user may provide a user request specifying an operation to be performed by the industrial device 110, thereby adjusting the industrial device 110 to reduce or address the difference between the actual value of the particular parameter as provided by the industrial device 110 and the simulated value of the particular parameter as computed by the industrial digital twin 160 using the simulation algorithm. In some embodiments, the user request may be provided via the user application 140 and the TMMS 150 may receive the user request.

As an example, the industrial device 110 may be a motor drive operating at a motor speed of 1000 rpm. In this example, the actual temperature of the industrial device 110 that is determined by the industrial device 110 and included in the second packet transmitted from the edge device 120 to the TMMS 150 may be 50°. On the other hand, the simulated temperature of the industrial device 110 that is computed by the industrial digital twin 160 using its simulation algorithm may be 35°. In this case, the user may evaluate the actual temperature of the industrial device 110 relative to the simulated temperature of the industrial device 110 and/or inspect the industrial device 110, and determine that the industrial device 110 is overheated. Accordingly, the user may provide a user request to decrease the motor speed of the industrial device 110 to a target value (e.g., 750 rpm) to lower the actual temperature of the industrial device 110, thereby reducing the difference between the actual temperature of the industrial device 110 and the simulated temperature of the industrial device 110.

In some embodiments, in response to the user request specifying the operation to be performed by the industrial device 110, the TMMS 150 may create a third packet associated with the second communication protocol (e.g., the MQTT protocol). The third packet may conform to the packet format of the second communication protocol and may indicate the operation to be performed by the industrial device 110. For example, the third packet may specify the type of action (e.g., decreasing motor speed) associated with the operation and also specify the relevant data of the operation (e.g., the target value of the operation, the device ID of the industrial device 110 that performs the operation, etc.). In some embodiments, the TMMS 150 may transmit the third packet associated with the second communication protocol to the edge device 120 in accordance with the second communication protocol. As described herein, the second communication protocol may be a high-latency low-speed communication protocol such as the MQTT protocol. Other implementations for generating the third packet associated with the second communication protocol in which the third packet indicates the operation to be performed by the industrial device 110 are also possible and contemplated.

In some embodiments, the edge device 120 may receive the third packet associated with the second communication protocol from the TMMS 150 on the cloud platform 104. The edge device 120 may then determine the operation to be performed by the industrial device 110 that is indicated in the third packet associated with the second communication protocol. For example, the edge device 120 may analyze the third packet to identify the type of action associated with the operation and the relevant data of the operation as indicated in the third packet. Based on the operation determined from the third packet, the edge device 120 may determine a plurality of device commands to be executed by the industrial device 110 to perform the operation. For example, the edge device 120 may reference a predefined script associated with the type of action (e.g., decreasing motor speed) indicated for the operation in the third packet, and determine a sequence of device commands to be executed to perform the operation. The edge device 120 may then populate these device commands based on the relevant data of the operation (e.g., the target value of the operation, the device ID of the industrial device 110 that performs the operation, etc.), thereby generating the device commands to be sequentially executed by the industrial device 110 to perform the operation being communicated from the TMMS 150 to the edge device 120.

Continuing the above example, the industrial device 110 (e.g., the motor drive) may be a CIP device that implements multiple CIP objects and the operation to be performed by the industrial device 110 that is indicated in the third packet may be to decrease the motor speed of the industrial device 110 to the target value of 750 rpm. In this example, the edge device 120 may reference a predefined script associated with the operation of decreasing motor speed, and identify one or more services (e.g., commands) of one or more CIP objects to be sequentially executed and/or identify one or more data attributes of one or more CIP objects that have their values to be established to decrease the motor speed of the industrial device 110. It should be understood that these services and these data attributes may belong to the same CIP object or may belong to different CIP objects implemented by the industrial device 110. The edge device 120 may then populate these services and/or specify the values of these data attributes with corresponding values based on the relevant data of the operation, thereby generating a plurality of device commands (e.g., CIP commands) to be executed by the industrial device 110 in sequence to decrease the motor speed of the industrial device 110 to the target value of 750 rpm.

In some embodiments, after the plurality of device commands to be executed by the industrial device 110 are determined, the edge device 120 may create a plurality of fourth packets associated with the first communication protocol (e.g., the CIP protocol) in which each fourth packet among the plurality of fourth packets may conform to the packet format of the first communication protocol and may specify one or more device commands among the plurality of device commands to be executed by the industrial device 110. The edge device 120 may then transmit the plurality of fourth packets associated with the first communication protocol to the industrial device 110 in accordance with the first communication protocol. As described herein, the first communication protocol may be the low-latency high-speed communication protocol such as the CIP protocol. Other implementations for generating the plurality of fourth packets associated with the first communication protocol are also possible and contemplated.

In some embodiments, the industrial device 110 may receive the plurality of fourth packets associated with the first communication protocol from the edge device 120. The industrial device 110 may then analyze the plurality of fourth packets to obtain the plurality of device commands to be executed by the industrial device 110 to perform the operation. In some embodiments, the industrial device 110 may execute the plurality of device commands indicated in the plurality of fourth packets to perform the operation. As described herein, the operation (e.g., decreasing the motor speed of the industrial device 110 to the target value of 750 rpm) may be requested by the user and may be communicated from the TMMS 150 to the edge device 120 in the third packet.

Thus, as described herein, the edge device 120 may receive one third packet that indicates the operation to be performed by the industrial device 110 from the TMMS 150 on the cloud platform 104, and create the plurality of fourth packets that specify the plurality of device commands to be executed by the industrial device 110 to perform the operation. The edge device 120 may then transmit the plurality of fourth packets to the industrial device 110. Accordingly, one third packet being transmitted from the TMMS 150 on the cloud platform 104 to the edge device 120 may trigger the plurality of fourth packets being transmitted from the edge device 120 to the industrial device 110 and cause the industrial device 110 to execute the plurality of device commands specified in the plurality of fourth packets to perform the operation. Accordingly, the number of packets being transmitted from the cloud platform 104 to cause the industrial device 110 to perform the operation may be minimized, and thus the transmission cost and the packet processing cost for communicating the operation to be performed by the industrial device 110 from the cloud platform 104 may be reduced.

In addition, as described herein, the third packet may be associated with the second communication protocol, and the TMMS 150 on the cloud platform 104 may transmit the third packet to the edge device 120 in accordance with the second communication protocol (e.g., the MQTT protocol). On the other hand, the plurality of fourth packets may be associated with the first communication protocol, and the edge device 120 may transmit the plurality of fourth packets to the industrial device 110 in accordance with the first communication protocol (e.g., the CIP protocol). As described herein, the second communication protocol may be the high-latency low-speed communication protocol, and the first communication protocol may be the low-latency high-speed communication protocol. Thus, the second communication protocol that is the high-latency low-speed communication protocol (e.g., the MQTT protocol) may be used for the communication between the TMMS 150 on the cloud platform 104 and the edge device 120 in which a relatively low number of packets are transmitted between the cloud platform 104 and the edge device 120. On the other hand, the first communication protocol that is the low-latency high-speed communication protocol (e.g., the CIP protocol) may be used for the communication between the edge device 120 and the industrial device 110 in which a higher number of packets are transmitted between the edge device 120 and the industrial device 110. As a result of this implementation, the overall efficiency in communication between the cloud platform 104, the edge device 120, and the industrial device 110 may be improved.

As described above, the TMMS 150 may transmit the third packet indicating the operation to be performed by the industrial device 110 to the edge device 120. The edge device 120 may determine the plurality of device commands to be executed by the industrial device 110 to perform the operation, create the plurality of fourth packets specifying the plurality of device commands to be executed by the industrial device 110, and transmit the plurality of fourth packets to the industrial device 110. In some embodiments, the plurality of device commands to be executed by the industrial device 110 to perform the operation may not be determined by the edge device 120 but instead be determined by the TMMS 150.

For example, in response to the user request specifying the operation to be performed by the industrial device 110, the TMMS 150 may determine the plurality of device commands to be executed by the industrial device 110 to perform the operation. In some embodiments, the TMMS 150 may determine the plurality of device commands to be executed by the industrial device 110 to perform the operation in a manner similar to the manner in which the edge device 120 determines the plurality of device commands to be executed by the industrial device 110 as described above. For example, the TMMS 150 may determine the type of action (e.g., decreasing motor speed) associated with the operation, and reference a predefined script associated with the type of action to determine a sequence of device commands to be executed to perform the operation. The TMMS 150 may also determine the relevant data of the operation (e.g., the target value of the operation, the device ID of the industrial device 110 that performs the operation, etc.) and populate these device commands based on the relevant data of the operation, thereby generating the plurality of device commands to be sequentially executed by the industrial device 110 to perform the operation.

In some embodiments, after the plurality of device commands to be executed by the industrial device 110 are determined, the TMMS 150 may create a third packet associated with the second communication protocol (e.g., the MQTT protocol). The third packet may conform to the packet format of the second communication protocol and may specify the plurality of device commands to be sequentially executed by the industrial device 110 to perform the operation. The TMMS 150 may then transmit the third packet associated with the second communication protocol to the edge device 120 in accordance with the second communication protocol. As described herein, the second communication protocol may be a high-latency low-speed communication protocol such as the MQTT protocol. Other implementations for generating the third packet associated with the second communication protocol in which the third packet specifies the plurality of device commands to be executed by the industrial device 110 are also possible and contemplated.

In some embodiments, the edge device 120 may receive the third packet associated with the second communication protocol from the TMMS 150 on the cloud platform 104. The edge device 120 may then analyze the third packet to obtain the plurality of device commands to be executed by the industrial device 110 to perform the operation. Based on the plurality of device commands to be executed by the industrial device 110 that are specified in the third packet, the edge device 120 may create a plurality of fourth packets associated with the first communication protocol (e.g., the CIP protocol) in which each fourth packet among the plurality of fourth packets may conform to the packet format of the first communication protocol and may specify one or more device commands among the plurality of device commands to be executed by the industrial device 110. The edge device 120 may then transmit the plurality of fourth packets associated with the first communication protocol to the industrial device 110 in accordance with the first communication protocol. As described herein, the first communication protocol may be the low-latency high-speed communication protocol such as the CIP protocol. Other implementations for generating the plurality of fourth packets associated with the first communication protocol are also possible and contemplated.

Thus, in this case, the edge device 120 may receive from the TMMS 150 on the cloud platform 104 one third packet associated with the second communication protocol (e.g., the MQTT protocol) that specifies the plurality of device commands to be executed by the industrial device 110 to perform the operation, and create the plurality of fourth packets associated with the first communication protocol (e.g., the CIP protocol) that specify the plurality of device commands to be executed by the industrial device 110 to perform the operation. The edge device 120 may then transmit the plurality of fourth packets associated with the first communication protocol to the industrial device 110 in accordance with the first communication protocol. Accordingly, one third packet being transmitted from the TMMS 150 on the cloud platform 104 to the edge device 120 may trigger the plurality of fourth packets being transmitted from the edge device 120 to the industrial device 110 and cause the industrial device 110 to execute the plurality of device commands specified in the plurality of fourth packets to perform the operation. Accordingly, the number of packets being transmitted from the cloud platform 104 to cause the industrial device 110 to execute the plurality of device commands to perform the operation may be minimized, and thus the transmission cost and the packet processing cost for communicating the plurality of device commands to be executed by the industrial device 110 from the cloud platform 104 may be reduced.

In addition, as described above, the third packet may be associated with the second communication protocol, and the TMMS 150 on the cloud platform 104 may transmit the third packet to the edge device 120 in accordance with the second communication protocol (e.g., the MQTT protocol). On the other hand, the plurality of fourth packets may be associated with the first communication protocol, and the edge device 120 may transmit the plurality of fourth packets to the industrial device 110 in accordance with the first communication protocol (e.g., the CIP protocol). As described herein, the second communication protocol may be the high-latency low-speed communication protocol, and the first communication protocol may be the low-latency high-speed communication protocol. Thus, the second communication protocol that is the high-latency low-speed communication protocol (e.g., the MQTT protocol) may be used for the communication between the TMMS 150 on the cloud platform 104 and the edge device 120 in which a relatively low number of packets are transmitted between the cloud platform 104 and the edge device 120. On the other hand, the first communication protocol that is the low-latency high-speed communication protocol (e.g., the CIP protocol) may be used for the communication between the edge device 120 and the industrial device 110 in which a higher number of packets are transmitted between the edge device 120 and the industrial device 110. As a result of this implementation, the overall efficiency in communication between the cloud platform 104, the edge device 120, and the industrial device 110 may be improved.

Thus, as described herein, the edge device 120 may facilitate the communication of the operation to be performed by the industrial device 110 from the TMMS 150 on the cloud platform 104 and/or facilitate the communication of multiple device commands to be executed by the industrial device 110 to perform the operation from the TMMS 150 on the cloud platform 104. Similarly, the edge device 120 may facilitate the communication of the operation to be performed by the industrial device 110 from the computing device 130 in the industrial facility 102 and/or facilitate the communication of multiple device commands to be executed by the industrial device 110 to perform the operation from the computing device 130 in the industrial facility 102.

As an example, the user may provide a user request specifying the operation to be performed by the industrial device 110 via the user application 140 implemented on the computing device 130, and the computing device 130 may receive the user request. In some embodiments, in response to the user request, the computing device 130 may create a third packet indicating the operation to be performed by the industrial device 110. For example, the third packet may specify the type of action (e.g., increasing input voltage) associated with the operation and also specify the relevant data of the operation (e.g., the target value of the operation, the device ID of the industrial device 110 that performs the operation, etc.). In some embodiments, the third packet may conform to the first communication protocol (e.g., the CIP protocol) or another low-latency high-speed communication protocol that is used to communicate between the computing device 130 and the edge device 120 in the industrial facility 102. In some embodiments, the computing device 130 may transmit the third packet to the edge device 120 in the industrial facility 102.

In some embodiments, the edge device 120 may receive the third packet from the computing device 130, and determine the operation to be performed by the industrial device 110 that is indicated in the third packet. For example, the edge device 120 may analyze the third packet to identify the type of action associated with the operation and the relevant data of the operation as indicated in the third packet. Based on the operation determined from the third packet, the edge device 120 may determine a plurality of device commands to be executed by the industrial device 110 to perform the operation. For example, the edge device 120 may reference a predefined script associated with the type of action (e.g., increasing input voltage) indicated for the operation in the third packet, and determine a sequence of device commands to be executed to perform the operation. The edge device 120 may then populate these device commands based on the relevant data of the operation (e.g., the target value of the operation, the device ID of the industrial device 110 that performs the operation, etc.), thereby generating the device commands to be sequentially executed by the industrial device 110 to perform the operation being communicated from the computing device 130 to the edge device 120.

In some embodiments, after the plurality of device commands to be executed by the industrial device 110 are determined, the edge device 120 may create a plurality of fourth packets associated with the first communication protocol (e.g., the CIP protocol) in which each fourth packet among the plurality of fourth packets may conform to the packet format of the first communication protocol and may specify one or more device commands among the plurality of device commands to be executed by the industrial device 110. The edge device 120 may then transmit the plurality of fourth packets associated with the first communication protocol to the industrial device 110 in accordance with the first communication protocol. Accordingly, the edge device 120 may instruct the industrial device 110 to execute the plurality of device commands in the plurality of fourth packets to perform the operation being communicated from the computing device 130 to the edge device 120.

In some embodiments, the industrial device 110 may receive the plurality of fourth packets associated with the first communication protocol from the edge device 120. The industrial device 110 may then analyze the plurality of fourth packets to obtain the plurality of device commands to be executed by the industrial device 110 to perform the operation. In some embodiments, the industrial device 110 may execute the plurality of device commands indicated in the plurality of fourth packets to perform the operation. As described herein, the operation (e.g., increasing the input voltage of the industrial device 110 to the target value) may be requested by the user and may be communicated from the computing device 130 to the edge device 120 in the third packet.

Thus, as described above, for the operation to be performed by the industrial device 110 that is communicated from the computing device 130 in the industrial facility 102 to the edge device 120 and for the operation to be performed by the industrial device 110 that is communicated from the TMMS 150 on the cloud platform 104 to the edge device 120, the edge device 120 may determine the plurality of device commands to be executed by the industrial device 110 to perform the operation, generate the plurality of fourth packets specifying these device commands, and transmit the plurality of fourth packets to the edge device 120 in similar manners. In some embodiments, instead of the edge device 120 determining the plurality of device commands to be executed by the industrial device 110 to perform the operation, the computing device 130 may determine the plurality of device commands in a manner similar to the manner in which the edge device 120 or the TMMS 150 determines the plurality of device commands as described herein. The computing device 130 may then create a third packet associated with the first communication protocol (e.g., the CIP protocol) or another low-latency high-speed communication protocol, in which the third packet may specify the plurality of device commands to be executed by the industrial device 110 to perform the operation. In some embodiments, the computing device 130 may transmit the third packet to the edge device 120 and the edge device 120 may receive the third packet. The edge device 120 may then analyze the third packet to obtain the plurality of device commands, create the plurality of fourth packets specifying the plurality of device commands, and transmit the plurality of fourth packets to the industrial device 110 in the manner described herein. The detailed description of these manners are not repeated here for brevity.

In some embodiments, the edge device 120 may be implemented in the form of a computing device that is capable of performing the operations of the computing device 130 described herein. For example, the edge device 120 may include the user application 140 and the user may provide a user request via the user application 140 on the edge device 120. For example, the user may provide via the user application 140 on the edge device 120 a user request specifying the operation to be performed by the industrial device 110. In this case, the edge device 120 may receive the user request that specifies the operation to be performed by the industrial device 110. The edge device 120 may then determine the plurality of device commands to be executed by the industrial device 110 to perform the operation, create the plurality of fourth packets specifying the plurality of device commands, and transmit the plurality of fourth packets to the industrial device 110 in the manner described herein. Accordingly, the edge device 120 may instruct the industrial device 110 to execute the plurality of device commands to perform the operation indicated in the user request provided by the user to the edge device 120.

Thus, as described herein, the edge device 120 may create the second packet that includes the device data associated with one industrial device 110 in the plurality of first packets received from the industrial device 110, and transmit the second packet to the TMMS 150 on the cloud platform 104. The TMMS 150 on the cloud platform 104 may extract the device data associated with the industrial device 110 from the second packet, and use the device data associated with the industrial device 110 in managing (e.g., evaluating, updating, etc.) the industrial digital twin of the industrial device 110 or the industrial digital twin of the industrial system that includes the industrial device 110. Additionally or alternatively, as described herein, the edge device 120 may create one second packet that includes the device data associated with various industrial devices 110 in the plurality of packets received from various industrial devices 110. The edge device 120 may then transmit the second packet to the TMMS 150. In this case, the TMMS 150 may extract the device data associated with various industrial devices 110 from the second packet, and use the device data associated with various industrial devices 110 in managing (e.g., evaluating, updating, etc.) the industrial digital twins of these industrial devices 110 or the industrial digital twin of the industrial system that includes one or more industrial devices 110 among these industrial devices 110. For example, for each industrial device 110 among various industrial devices 110, the TMMS 150 may obtain the device data associated with the industrial device 110 in the device data associated with various industrial devices 110 extracted from the second packet, and use the device data associated with the industrial device 110 to manage (e.g., evaluate, update, etc.) the industrial digital twin of the industrial device 110 or the industrial digital twin of the industrial system that includes the industrial device 110 in the manner described herein. Accordingly, in this case, the device data of different industrial devices 110 that is transmitted to the TMMS 150 in the same second packet may be used to manage (e.g., evaluate, update, etc.) the industrial digital twins of different industrial devices 110, the industrial digital twin of the industrial system that includes one or more industrial devices 110 among these industrial devices 110, etc.

Similarly, as described herein, the TMMS 150 may create the third packet that indicates the operation to be performed by the industrial device 110, and transmit the third packet to the edge device 120. The edge device 120 may then determine the plurality of device commands to be executed by the industrial device 110 to perform the operation indicated in the third packet, create the plurality of fourth packets specifying the plurality of device commands, and transmit the plurality of fourth packets to the industrial device 110. Additionally or alternatively, the TMMS 150 may create the third packet that indicates multiple operations to be performed by one or more industrial devices 110, and transmit the third packet to the edge device 120. In this case, for each operation to be performed by a particular industrial device 110 as indicated in the third packet, the edge device 120 may determine the plurality of device commands to be executed by the particular industrial device 110 to perform the operation, create the plurality of fourth packets specifying the plurality of device commands, and transmit the plurality of fourth packets to the particular industrial device 110 in the manner described herein. Accordingly, in this case, the third packet transmitted from the TMMS 150 may indicate different operations and may result in one industrial device 110 executing multiple device commands to perform these different operations or may result in different industrial devices 110 each executing multiple device commands to perform one or more operations among these different operations indicated in the third packet. In some embodiments, the third packet transmitted from the TMMS 150 may indicate different operations to be performed by different industrial devices 110 that work together. For example, these industrial devices 110 may collaborate with one another in an industrial process or may be part of the same industrial system (e.g., a workstation or a manufacturing line). As another example, these industrial devices 110 may include a first industrial device 110 and a second industrial device 110, in which an output of the first industrial device 110 may be provided as an input to the second industrial device 110 or vice versa.

Embodiments, systems, and components described herein, as well as control systems and automation environments in which various aspects set forth in the present disclosure may be carried out, may include computer or network components such as servers, clients, programmable logic controllers (PLCs), automation controllers, communications modules, mobile computers, on-board computers for mobile vehicles, wireless components, control components and so forth which are capable of interacting across a network. Computers and servers may include one or more processors (e.g., electronic integrated circuits that perform logic operations using electric signals) configured to execute instructions stored in media such as random access memory (RAM), read only memory (ROM), hard drives, as well as removable memory devices (e.g., memory sticks, memory cards, flash drives, external hard drives, etc.).

Similarly, the term PLC or automation controller as used herein may include functionality that can be shared across multiple components, systems, and/or networks. As an example, one or more PLCs or automation controllers may communicate and cooperate with various network devices across the network. These network devices may include any type of control, communications module, computer, Input/Output (I/O) device, sensor, actuator, and human machine interface (HMI) that communicate via the network, which includes control, automation, and/or public networks. The PLC or automation controller may also communicate with and may control other devices such as standard or safety-rated I/O modules including analog, digital, programmed/intelligent I/O modules, other programmable controllers, communication modules, sensors, actuators, output devices, and the like.

The network may include public networks such as the Internet, intranets, and automation networks such as control and information protocol (CIP) networks including DeviceNet, ControlNet, safety networks, and Ethernet/IP. Other networks may include Ethernet, DH/DH+, Remote I/O, Fieldbus, Modbus, Profibus, CAN, wireless networks, serial protocols, etc. In addition, the network devices may include various possibilities (hardware and/or software components). The network devices may also include components such as switches with virtual local area network (VLAN) capability, LANs, WANs, proxies, gateways, routers, firewalls, virtual private network (VPN) devices, servers, clients, computers, configuration tools, monitoring tools, and/or other devices.

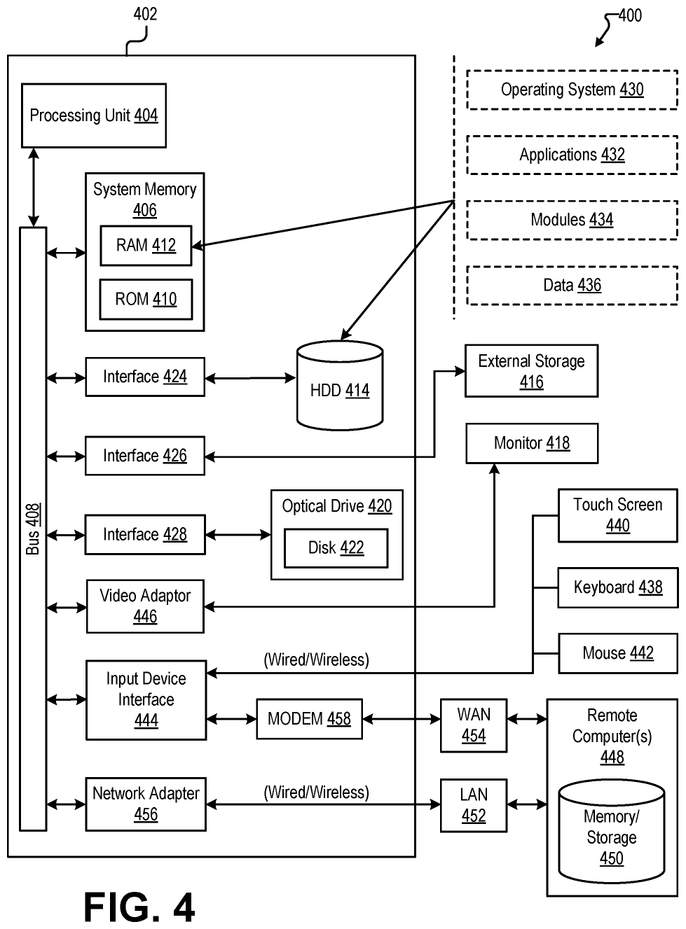

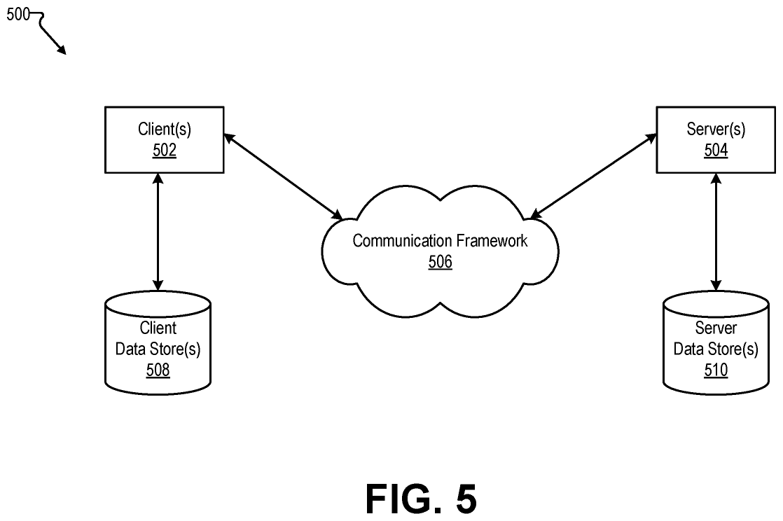

To provide a context for various aspects of the present disclosure, FIGS. 4 and 5 illustrate an exemplary environment in which various aspects of the present disclosure may be implemented. While the embodiments are described herein in the general context of computer-executable instructions that can be executed on one or more computers, it should be understood that the embodiments may also be implemented in combination with other program modules and/or implemented as a combination of hardware and software.

The program modules may include routines, programs, components, data structures, etc., that perform particular tasks or may implement particular abstract data types. Moreover, it should be understood that the methods described herein may be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which may be operatively coupled to one or more associated devices.

The exemplary embodiments described herein may also be practiced in distributed computing environments where certain tasks may be performed by remote processing devices that are linked through a communications network. In a distributed computing environment, program modules may be located in both local and remote memory storage devices.

Computing devices may include a variety of media, which may include computer-readable storage media, machine-readable storage media, and/or communications media. Computer-readable storage media or machine-readable storage media may be any available storage media that can be accessed by the computer and may include both volatile and nonvolatile media, removable and non-removable media. By way of example and not limitation, computer-readable storage media or machine-readable storage media may be implemented in connection with any method or technology for storage of information such as computer-readable or machine-readable instructions, program modules, structured data or unstructured data. Computer-readable storage media may be accessed by one or more local or remote computing devices (e.g., via access requests, queries, or other data retrieval protocols) for various operations with respect to the information stored in the computer-readable storage media.

Examples of computer-readable storage media may include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage, or other magnetic storage devices, or other solid state storage devices, or other tangible and/or non-transitory media, which may be used to store desired information. The terms “tangible” or “non-transitory” as applied to storage, memory or computer-readable media herein, should be understood to exclude only propagating transitory signals per se as modifiers and do not relinquish rights to all standard storage, memory, or computer-readable media that are not only propagating transitory signals per sc.

Communications media may embody computer-readable instructions, data structures, program modules, or other structured or unstructured data in a data signal such as a modulated data signal (e.g., a carrier wave or other transport mechanism) and may include any information delivery or transport media. The term “modulated data signal” or signals refers to a signal that has one or more of its characteristics set or changed to encode information in one or more signals. By way of example and not limitation, communication media may include wired media (e.g., a wired network or direct-wired connection) and wireless media (e.g., acoustic, RF, infrared, etc.).

FIG. 4 illustrates an example environment 400 for implementing various embodiments of the aspects described herein. For example, the environment 400 may implement the system 100, the cloud platform 104, the industrial device 110, the edge device 120, the computing device 130, the TMMS 150, and/or other systems and their components described herein. As depicted in FIG. 4, the environment 400 may include a computing device 402. The computing device 402 may include a processing unit 404, a system memory 406, and a system bus 408. The system bus 408 may couple various system components such as the system memory 406 to the processing unit 404. The processing unit 404 may be any commercially available processor. Dual microprocessors and other multi-processor architectures may also be used as the processing unit 404.

The system bus 408 may be a bus structure that can further interconnect to a memory bus (with or without a memory controller), a peripheral bus, and/or a local bus using any commercially available bus architecture. The system memory 406 may include ROM 410 and RAM 412. A basic input/output system (BIOS) may be stored in a non-volatile memory such as ROM, erasable programmable read only memory (EPROM), EEPROM, etc. BIOS may contain the basic routines for transferring information between elements in the computing device 402, such as during startup. The RAM 412 may also include a high-speed RAM such as static RAM for caching data.

The computing device 402 may additionally include an internal hard disk drive (HDD) 414 (e.g., EIDE, SATA), one or more external storage devices 416 (e.g., a magnetic floppy disk drive (FDD), a memory stick or flash drive reader, a memory card reader, etc.), and an optical disk drive 420 (which may read or write from a CD-ROM disc, a DVD, a BD, etc.). While the internal HDD 414 is illustrated as located within the computing device 402, the internal HDD 414 may also be configured for external use in a suitable chassis (not shown). Additionally, while not shown in the environment 400, a solid state drive (SSD) may be used in addition to, or in place of, the HDD 414. The HDD 414, external storage device(s) 416, and optical disk drive 420 may be connected to the system bus 408 by an HDD interface 424, an external storage interface 426, and an optical drive interface 428, respectively. The interface 424 for external drive implementations may include at least one or both of Universal Serial Bus (USB) and Institute of Electrical and Electronics Engineers (IEEE) 1394 interface technologies. Other external drive connection technologies are also possible and contemplated.

The drives and their associated computer-readable storage media may provide nonvolatile storage of data, data structures, computer-executable instructions, etc. In the computing device 402, the drives and storage media may accommodate the storage of any data in a suitable digital format. Although the description of computer-readable storage media above refers to respective types of storage devices, it should be understood that other types of storage media which are readable by a computer, whether presently existing or developed in the future, may also be used in the example operating environment 400, and that any such storage media may contain computer-executable instructions for performing the methods described herein.

A number of program modules may be stored in the drives and RAM 412, including an operating system 430, one or more application programs 432, other program modules 434, and program data 436. All or portions of the operating system 430, the applications 432, the modules 434, and/or the data 436 may also be cached in the RAM 412. The systems and methods described herein may be implemented using various operating systems or combinations of operating systems that are commercially available.

The computing device 402 may optionally include emulation technologies. For example, a hypervisor (not shown) or other intermediary may emulate a hardware environment for the operating system 430, and the emulated hardware may optionally be different from the hardware illustrated in FIG. 4. In such an embodiment, the operating system 430 may comprise one virtual machine (VM) of multiple VMs hosted on the computing device 402. Furthermore, the operating system 430 may provide runtime environments (e.g., the Java runtime environment or the .NET framework) for the application programs 432. The runtime environments may be consistent execution environments that allow application programs 432 to run on any operating system that includes the runtime environment. Similarly, the operating system 430 may support containers, and application programs 432 may be in the form of containers, which are lightweight, standalone, executable packages of software that include code, runtime, system tools, system libraries, settings, and/or other components for executing an application.

In addition, the computing device 402 may be enabled with a security module, such as a trusted processing module (TPM). For example, with a TPM, boot components may hash next-in-time boot components, and wait for a match of results to secured values, before loading a next boot component. This process may take place at any layer in the code execution stack of the computing device 402 (e.g., applied at the application execution level or at the operating system (OS) kernel level) thereby enabling security at any level of code execution.

A user may enter commands and information into the computing device 402 through one or more wired/wireless input devices (e.g., a keyboard 438, a touch screen 440, and a pointing device, such as a mouse 442). Other input devices (not shown) may include a microphone, an infrared (IR) remote control, a radio frequency (RF) remote control, or other remote control, a joystick, a virtual reality controller and/or virtual reality headset, a game pad, a stylus pen, an image input device (e.g., one or more cameras), a gesture sensor input device, a vision movement sensor input device, an emotion or facial detection device, a biometric input device (e.g., fingerprint or iris scanner), etc. These input devices and other input devices may be connected to the processing unit 404 through an input device interface 444 that may be coupled to the system bus 408, but may be connected by other interfaces, such as a parallel port, an IEEE 1394 serial port, a game port, a USB port, an IR interface, a BLUETOOTH® interface, etc.

A monitor 418 or other type of display device may be also connected to the system bus 408 via an interface, such as a video adapter 446. In addition to the monitor 418, the computing device 402 may also include other peripheral output devices (not shown), such as speakers, printers, etc.

The computing device 402 may operate in a networked environment using logical connections via wired and/or wireless communications to one or more remote computers, such as remote computer(s) 448. The remote computer(s) 448 may be a workstation, a server computer, a router, a personal computer, portable computer, microprocessor-based entertainment appliance, a peer device, or other common network node. The remote computer(s) 448 may include many or all of the elements in the computing device 402 although only a memory/storage device 450 is illustrated for purposes of brevity. As depicted in FIG. 4, the logical connections of remote computer(s) 448 may include wired/wireless connectivity to a local area network (LAN) 452 and/or to larger networks such as a wide area network (WAN) 454. Such LAN and WAN networking environments may be commonplace in offices and companies, and may facilitate enterprise-wide computer networks (e.g., intranets) all of which may connect to a global communications network (e.g., the Internet).

When used in a LAN networking environment, the computing device 402 may be connected to the local network 452 through a wired and/or wireless communication network interface or adapter 456. The adapter 456 may facilitate wired or wireless communication to the LAN 452, which may also include a wireless access point (AP) disposed thereon for communicating with the adapter 456 in a wireless mode.

When used in a WAN networking environment, the computing device 402 may include a modem 458 or may be connected to a communication server on the WAN 454 via other means to establish communication over the WAN 454, such as by way of the Internet. The modem 458, which may be internal or external and a wired or wireless device, may be connected to the system bus 408 via the input device interface 444. In a networked environment, program modules that are depicted relative to the computing device 402 or portions thereof, may be stored in the remote memory/storage device 450. It should be understood that the network connections depicted in FIG. 4 are merely example and other implementations to establish a communication link between the computers/computing devices are also possible and contemplated.

When used in either a LAN or WAN networking environment, the computing device 402 may access cloud storage systems or other network-based storage systems in addition to, or in place of, the external storage devices 416 as described herein. In some embodiments, a connection between the computing device 402 and a cloud storage system may be established over the LAN 452 or WAN 454 (e.g., by the adapter 456 or the modem 458, respectively). Upon connecting the computing device 402 to an associated cloud storage system, the external storage interface 426 may, with the aid of the adapter 456 and/or the modem 458, manage the storage provided by the cloud storage system as it would for other types of external storage. For example, the external storage interface 426 may be configured to provide access to cloud storage resources as if those resources were physically connected to the computing device 402.

The computing device 402 may be operable to communicate with any wireless devices or entities operatively disposed in wireless communication such as a printer, scanner, desktop and/or portable computer, portable data assistant, communications satellite, any piece of equipment or location associated with a wirelessly detectable tag (e.g., a kiosk, news stand, store shelf, etc.), telephone, etc. This communication may use Wireless Fidelity (Wi-Fi) and BLUETOOTH® wireless technologies. Thus, the communication may be a predefined structure as in a conventional network or simply an ad hoc communication between at least two devices.

FIG. 5 illustrates an exemplary computing environment 500 with which the embodiments described herein may be implemented. The computing environment 500 may include one or more client(s) 502. The client(s) 502 may be hardware and/or software (e.g., threads, processes, computing devices). The computing environment 500 may also include one or more server(s) 504. The server(s) 504 may also be hardware and/or software (e.g., threads, processes, computing devices). For example, the servers 504 may house threads that implement one or more embodiments described herein. One possible communication between a client 502 and servers 504 may be in the form of a data packet adapted to be transmitted between two or more computer processes. The computing environment 500 may include a communication framework 506 that may facilitate communications between the client(s) 502 and the server(s) 504. The client(s) 502 may be operably connected to one or more client data store(s) 508 that may be used to store information local to the client(s) 502. Similarly, the server(s) 504 may be operably connected to one or more server data store(s) 510 that may be used to store information local to the servers 504.

The foregoing description has been presented for the purposes of illustration and description. It is not intended to be exhaustive or to limit the specification to the precise form disclosed. Many modifications and variations are possible in light of the above teaching. It is intended that the scope of the disclosure is not limited by this detailed description and the modifications and variations that fall within the spirit and scope of the appended claims are included. As will be understood by those familiar with the art, the specification may be embodied in other specific forms without departing from the spirit or essential characteristics thereof.

In particular and with regard to various functions performed by the above-described components, devices, circuits, systems, and/or the like, the terms (including a reference to a “means”) used to describe such components are intended to correspond, unless otherwise indicated, to any component which performs the specified function of the described component (e.g., a functional equivalent), even if such component may not be structurally equivalent to the described structure, which illustrates exemplary aspects of the present disclosure. In this regard, it should also be recognized that the present disclosure includes a system as well as a computer-readable medium having computer-executable instructions for performing the acts and/or events of various methods described herein.

In addition, while a particular feature of the present disclosure may have been disclosed with respect to only one of several implementations, such feature may be combined with one or more other features of the other implementations as may be desired and advantageous for a given application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Instead, the use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from a computer-readable device, carrier, or media. For example, computer readable media may include, but are not limited to, magnetic storage devices (e.g., hard disk, floppy disk, magnetic strips, etc.), optical disks (e.g., compact disk (CD), digital versatile disk (DVD), etc.), smart cards, and flash memory devices (e.g., card, stick, key drive, etc.).

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by an edge device of an industrial facility, a plurality of first packets associated with a first communication protocol from an industrial device of the industrial facility;
extracting, by the edge device, device data associated with the industrial device from the plurality of first packets associated with the first communication protocol;
creating, by the edge device, a second packet associated with a second communication protocol, the second packet including the device data associated with the industrial device in the plurality of first packets; and
transmitting, by the edge device, the second packet associated with the second communication protocol to a cloud platform to manage an industrial digital twin on the cloud platform based on the second packet.

2. The method of claim 1, wherein:
the industrial digital twin is one of a virtual model of the industrial device or a virtual model of an industrial system that includes the industrial device.

3. The method of claim 1, wherein:
the first communication protocol is a low-latency communication protocol; and
the second communication protocol is a high-latency communication protocol, wherein a maximum packet size associated with the first communication protocol is lower than a maximum packet size associated with the second communication protocol.

4. The method of claim 1, wherein creating the second packet associated with the second communication protocol includes:
aggregating the device data associated with the industrial device in the plurality of first packets to form data of the second packet; and
generating metadata for the second packet, wherein for each first packet among the plurality of first packets, the metadata indicates a portion within the data of the second packet that corresponds to the first packet.

5. The method of claim 1, wherein the cloud platform includes a twin model management system, the twin model management system is configured to:
receive the second packet associated with the second communication protocol from the edge device;
extract the device data associated with the industrial device from the second packet based on metadata of the second packet; and
compare the device data associated with the industrial device to simulation data associated with the industrial device generated by the industrial digital twin.

6. The method of claim 5, wherein the twin model management system is further configured to:
determine, based on the comparing, that an actual value of a particular parameter in the device data associated with the industrial device is different from a simulated value of the particular parameter in the simulation data associated with the industrial device generated by the industrial digital twin; and
provide, in response to the determining, a notification to a user indicating that the actual value of the particular parameter is different from the simulated value of the particular parameter generated by the industrial digital twin.

7. The method of claim 6, wherein the twin model management system is further configured to:
receive, in response to the notification, a user request to synchronize the industrial digital twin with the industrial device; and
update, in response to the user request, the simulated value of the particular parameter in the industrial digital twin to be equal to the actual value of the particular parameter in the device data associated with the industrial device.

8. The method of claim 6, wherein the twin model management system is further configured to:
receive, in response to the notification, a user request specifying an operation to be performed by the industrial device;
create, in response to the user request, a third packet indicating the operation to be performed by the industrial device, the third packet being associated with the second communication protocol; and
transmit the third packet associated with the second communication protocol to the edge device.

9. The method of claim 1, further comprising:
receiving, by the edge device, a third packet associated with the second communication protocol from a twin model management system implemented on the cloud platform;
determining, by the edge device, an operation to be performed by the industrial device that is indicated in the third packet associated with the second communication protocol;
determining, by the edge device and based on the operation, a plurality of device commands to be executed by the industrial device to perform the operation;
creating, by the edge device, a plurality of fourth packets associated with the first communication protocol, wherein each fourth packet among the plurality of fourth packets specifies one or more device commands among the plurality of device commands to be executed by the industrial device; and
transmitting, by the edge device, the plurality of fourth packets associated with the first communication protocol to the industrial device.

10. The method of claim 1, further comprising:
receiving, by the edge device, a third packet from a computing device in the industrial facility;
determining, by the edge device, an operation to be performed by the industrial device that is indicated in the third packet;
determining, by the edge device and based on the operation, a plurality of device commands to be executed by the industrial device to perform the operation;
creating, by the edge device, a plurality of fourth packets associated with the first communication protocol, wherein each fourth packet among the plurality of fourth packets specifies one or more device commands among the plurality of device commands to be executed by the industrial device; and
transmitting, by the edge device, the plurality of fourth packets associated with the first communication protocol to the industrial device.

11. An edge device of an industrial facility, the edge device comprising:
a memory storing instructions; and
a processor communicatively coupled to the memory and configured to execute the instructions to:
receive a plurality of first packets associated with a first communication protocol from an industrial device of the industrial facility;
extract device data associated with the industrial device from the plurality of first packets associated with the first communication protocol;
create a second packet associated with a second communication protocol, the second packet including the device data associated with the industrial device in the plurality of first packets; and
transmit the second packet associated with the second communication protocol to a cloud platform to manage an industrial digital twin on the cloud platform based on the second packet.

12. The edge device of claim 11, wherein:
the industrial digital twin is one of a virtual model of the industrial device or a virtual model of an industrial system that includes the industrial device.

13. The edge device of claim 11, wherein:
the first communication protocol is a low-latency communication protocol; and
the second communication protocol is a high-latency communication protocol, wherein a maximum packet size associated with the first communication protocol is lower than a maximum packet size associated with the second communication protocol.

14. The edge device of claim 11, wherein creating the second packet associated with the second communication protocol includes:
aggregating the device data associated with the industrial device in the plurality of first packets to form data of the second packet; and
generating metadata for the second packet, wherein for each first packet among the plurality of first packets, the metadata indicates a portion within the data of the second packet that corresponds to the first packet.

15. A system comprising the edge device of claim 11 and a twin model management system implemented on the cloud platform, wherein the twin model management system is configured to:
receive the second packet associated with the second communication protocol from the edge device;
extract the device data associated with the industrial device from the second packet based on metadata of the second packet; and
compare the device data associated with the industrial device to simulation data associated with the industrial device generated by the industrial digital twin.

16. The system of claim 15, wherein the twin model management system is further configured to:
determine, based on the comparing, that an actual value of a particular parameter in the device data associated with the industrial device is different from a simulated value of the particular parameter in the simulation data associated with the industrial device generated by the industrial digital twin; and
provide, in response to the determining, a notification to a user indicating that the actual value of the particular parameter is different from the simulated value of the particular parameter generated by the industrial digital twin.

17. The system of claim 16, wherein the twin model management system is further configured to:
receive, in response to the notification, a user request to synchronize the industrial digital twin with the industrial device; and
update, in response to the user request, the simulated value of the particular parameter in the industrial digital twin to be equal to the actual value of the particular parameter in the device data associated with the industrial device.

18. The system of claim 16, wherein the twin model management system is further configured to:
receive, in response to the notification, a user request specifying an operation to be performed by the industrial device;
create, in response to the user request, a third packet indicating the operation to be performed by the industrial device, the third packet being associated with the second communication protocol; and
transmit the third packet associated with the second communication protocol to the edge device.

19. The edge device of claim 11, wherein the processor is further configured to execute the instructions to:
receive a third packet associated with the second communication protocol from a twin model management system implemented on the cloud platform;
determine an operation to be performed by the industrial device that is indicated in the third packet associated with the second communication protocol;
determine, based on the operation, a plurality of device commands to be executed by the industrial device to perform the operation;
create a plurality of fourth packets associated with the first communication protocol, wherein each fourth packet among the plurality of fourth packets specifies one or more device commands among the plurality of device commands to be executed by the industrial device; and
transmit the plurality of fourth packets associated with the first communication protocol to the industrial device.

20. A non-transitory computer-readable medium storing instructions that, when executed, direct a processor of a computing device to:
receive a plurality of first packets associated with a first communication protocol from an industrial device of an industrial facility;
extract device data associated with the industrial device from the plurality of first packets associated with the first communication protocol;
create a second packet associated with a second communication protocol, the second packet including the device data associated with the industrial device in the plurality of first packets; and
transmit the second packet associated with the second communication protocol to a cloud platform to manage an industrial digital twin on the cloud platform based on the second packet.
